(19) United States
(12) Patent Application Publication
(10) Pub. No.: US 2010/0045567 A1
(43) Pub. Date: Feb. 25, 2010

(54) SYSTEMS AND METHODS FOR FACILITATING PRESENTATION

(76) Inventor: FRANK C. H. LIN, Saratoga, CA (US)

Correspondence Address: YI-MING TSENG, P.O. BOX 19428, STANFORD, CA, 94309-9428, US

(21) Appl. No.: 12/267,573

(22) Filed: Nov. 8, 2008

Related U.S. Application Data
(60) Provisional application No. 61/189,435, filed on Aug. 19, 2008.

(51) Int. Cl. G09G 5/00

(52) U.S. Cl. 345/1.1

(57) ABSTRACT

A method for facilitating presentation made by at least a first user to a set of users including a second user. The first user uses a first device having and/or associated with a first display area. The second user uses a second device having and/or associated with a second display area. The method may include generating a first presentation window within the first display area. The first presentation window may be smaller than the first display area with a first remaining area being formed in the first display area and outside the first presentation window. The method may also include receiving at the first presentation window a representation of a first object. The method may also include generating a first presentation object according to the first object. The method may also include filling the second display area with a first copy of the first presentation object.

### CROSS-REFERENCE TO RELATED APPLICATIONS/PRIORITY CLAIM

This application is related to and claims priority under 35 U.S.C. §119(e) to a provisional application for patent entitled “SYSTEMS AND METHODS FOR FACILITATING PRESENTATION,” by Frank C. H. Lin, Application Ser. No. 61/189,435 filed on Aug. 19, 2008, which is incorporated herein by reference.

### BACKGROUND OF THE INVENTION

The present invention relates to systems and methods for facilitating presentations. More particularly, the present invention relates to systems and methods for facilitating presentations that utilize visual aids.

Presentation may represent an important type of activity among various types of activity in various fields, such as business, education, politics, etc. Visual aids, such as text, charts, and/or images shown in slides, may substantially help improve effectiveness of presentations in many instances. A conventional technique for providing visual aids in a presentation may involve using a projector connected to a computer. The speaker (or presenter) may operate a visual aid software application on the computer to control the display of visual aid material (e.g., slides), and the visual aid material (e.g., slides) may be projected by the projector to show on a surface (e.g., a screen or a wall).

In general, the projector may project the same content as shown on the computer display. Therefore, when the visual aid application is in a full-screen slideshow mode, the speaker may not have access to other applications or files that are operating or stored in the computer. On the other hand, when the visual aid application is not in the full-screen slideshow mode, all information (such email messages, confidential/private data, etc.) shown on the speaker's computer display may be projected on the surface and seen by the audience (or listeners). As a result, privacy and/or confidentiality may be compromised. In addition, activities on the speaker's computer display, such as a pop-up window indicating the arrival of an instant message or a pop-up message reminding about software update, may distract the listeners.

There also may be other problems associated with using a projector. For example, the problems may include one or more of unavailability of the projector, lengthy setup time of the projector, lack of a connection cable to couple the projector with the computer, incompatibility between the computer and the projector, incorrect configuration of the projector and/or the computer, etc.

Another convention technique for providing visual aids in a presentation may involve sharing the presenter's “desktop,” or the content shown on the presenter's computer display, with listeners. The technique may require the presenter's computer and each listener's computer to pre-install a client application. The technique may also require the presenter's computer and each listener's computer to be connected to a server. The server may enable the client application to show the presenter's “desktop” in a window on each listener's computer display. By sharing the “desktop,” the technique may also have the privacy, confidentiality, and/or distraction problems mentioned above.

The “desktop-sharing” technique may typically require each listener to receive a passcode/key and to use the passcode/key to perform log-in before the listener can join the presentation session. Much inconvenience of the listeners may be involved.

The “desktop-sharing” technique may also suffer latency/delay problems when the processing capacity of the server and/or when the bandwidth for connecting the computers with server is insufficient. As a result, what the listeners see may not be in synchronization with what the presenter shows. Consequently, there may be confusion and ineffectiveness in the presentation.

### SUMMARY

An embodiment of the present invention relates to a method for facilitating presentation made by at least a first user to a set of users. The set of users may include a second user. The first user is a user of a first device; the first device may have and/or may be associated with a first display area. The second user is a user of a second device; the second device may have and/or may be associated with a second display area. The method may include generating a first presentation window within the first display area. The first presentation window may be smaller than the first display area with a first remaining area being formed in the first display area and outside the first presentation window. The first display area may represent all displaying area associated with the first device for emitting or reflecting light in various colors simultaneously in different portions of the first display area to show one or more images, wherein the images may be generated with use of at least software in the first device. The method may also include receiving at the first presentation window a representation of a first object, the first object being selected from the first remaining area. The method may also include generating a first presentation object according the first object. The method may also include filling the second display area with a first copy of the first presentation object. The second display area may represent all displaying area associated with the second device for simultaneously emitting or reflecting light of different wavelengths to show at least one image, wherein the image may be generated with use of at least software in the second device. The first presentation window and the first remaining area may be present in the first display area when the second display area is filled with the first copy of the first presentation object.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows a schematic diagram illustrating an arrangement including a hub device coupled with other devices for facilitating presentation in accordance with one or more embodiments of the present invention.

FIG. 1B shows a schematic diagram illustrating an arrangement including connected devices for facilitating presentation in accordance with one or more embodiments of the present invention.

FIG. 2A shows a schematic diagram illustrating one or more steps in a method for facilitating presentation in accordance with one or more embodiments of the present invention.

FIG. 2B shows a schematic diagram illustrating one or more steps in a method for facilitating presentation in accordance with one or more embodiments of the present invention.

FIG. 3A shows a schematic diagram illustrating one or more steps in a method for facilitating presentation in accordance with one or more embodiments of the present invention.

FIG. 3B shows a schematic diagram illustrating one or more steps in a method for facilitating presentation in accordance with one or more embodiments of the present invention.

FIG. 3C shows a schematic diagram illustrating one or more steps in a method for facilitating presentation in accordance with one or more embodiments of the present invention.

FIG. 3D shows a schematic diagram illustrating one or more steps in a method for facilitating presentation in accordance with one or more embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

One or more embodiments of the present invention relate to a method for facilitating presentation made by at least a first user to a set of users. The set of users may include a second user. The first user may be a user of a first device; the first device may have and/or may be associated with a first display area. The second user may be a user of a second device; the second device may have and/or may be associated with a second display area. For example, each of the devices may represent a computing device, a communication device, a presentation device, and/or an entertainment device, such as a computer, a cellular phone, a projector, and/or a video game console.

The method may include generating a first presentation window within the first display area. The first presentation window may be smaller than the first display area with a first remaining area being formed in the first display area and outside the first presentation window. The first display area may represent all displaying area associated with the first device for emitting or reflecting light in various colors simultaneously in different portions of the first display area to show one or more images, wherein the images may be generated with use of at least software in the first device. For example, the first display area may represent the viewable area of a liquid crystal display included in or connected to the first device. As another example, the first display area may represent the projected area produced by a projector connected to the first device.

The method may also include receiving at the first presentation window a representation of a first object. For example, the first object may be an icon that represents or is associated with a digital file. As another example, the first object may be a file directory path, an Internet Protocol (IP) address, and/or a uniform resource locator (URL) associated with a file, a website, or a webpage. As another example, the first object may be a piece of presentation material, such as a portion of a file, a page of a document, a presentation slide, an image, a video/audio piece, and/or at least a portion of a spreadsheet.

The first object may be selected from the first remaining area. For example, the representation of the first object may be “dragged” from the first remaining area and “dropped” to the first presentation window by the first user. Alternatively or additionally, the representation of the first object may be “copied” or “cut” from the first remaining area and then “pasted” to the first presentation window by the first user. As an example, the representation of the first object may be a “dropped” or “pasted” image, copy, or gesture that represents the first object. The “drag”, “drop”, “copy”, “cut”, and “paste” actions may represent actions well-known in the art that are performed by a user in operating a graphical user interface.

The method may also include rendering the first object to produce a first presentation object, e.g., generating and/or retrieving the first presentation object according to the first object. For example, the first presentation object may include a portion of a file, a page of a document, a presentation slide, an image, a webpage, a table, a picture, a diagram, text, an audio/video piece, and/or at least a portion of a spreadsheet.

The method may also include filling the second display area with a copy of the first presentation object. The second display area may represent all displaying area associated with the second device for simultaneously emitting or reflecting light of different wavelengths to show at least one image, wherein the image may be generated with use of at least software in the second device. For example, the second display area may represent the viewable area of a liquid crystal display included in or connected to the second device. As another example, the second display area may represent the projected area produced by a projector connected to the second device. Advantageously, the first copy of the first presentation object may be zoomed to the maximum size on the second display area to provide maximum clarity for the second user.

Similarly, each of other display areas of other devices connected to the first device also may be filled with a copy of the first presentation object.

The first presentation window and the first remaining area may be present in the first display area and viewable to the first user when each display area of other devices (including the second display area) used by other users attending the presentation, or the listeners, is filled with a copy of the first presentation object. With each of the listener's display area being filled with a copy of the first presentation object, the listeners may not be able to see what is shown in the first remaining area. Advantageously, potential privacy and/or confidentiality problems for the first user and potential distraction problems for the listeners during the presentation, such as those common with the prior art as discussed in the Background of the Invention, may be avoided.

One or more embodiments of the invention relate to a method for facilitating presentation made by at least a first user to a set of users that includes at least a second user. The first user may be a user of a first device; the first device may have and/or may be associated with a first display area. The second user may be a user of a second device; the second device may have and/or may be associated with a second display area. For example, each of the devices may represent a computing device, a communication device, a presentation device, and/or an entertainment device, such as a computer, a cellular phone, a projector, and/or a video game console. A display area may represent all displaying area associated with (e.g., included in or connected to) a device for emitting or reflecting light in various colors simultaneously in different portions of the display area to show one or more images, wherein the images may be generated with use of at least software in the device.

The method may include detecting one or more devices that are connected to the first device. For example, the detected devices may be directly or indirectly connected to the first device through one or more of a wired connection, a wireless connection, an ad-hoc network, an intranet, and the Internet.

The method may also include discovering the second device, which may be connected to the first device. The method may also include providing a second-device icon in the first display area. In one or more embodiments, the second-device icon may be provided in a peer window in the first display area, wherein the peer window may be generated for showing discovered devices that are connected to the first device (and that are capable of showing presentation material).

The method may also include associating the second-device icon with at least one of the second device and the second user. The second-device icon may show a symbol, a number, and/or text that may represent the second device and/or the second user for identification purposes. According to the second-device icon, the first user may determine whether to provide the presentation material to the second device/user. Advantageously, at least some security and/or confidentiality problems may be prevented.

The method may also include receiving at the second-device icon a representation of a first object. For example, the first object may be an icon that represents or is associated with a digital file. As another example, the first object may be an Internet Protocol (IP) address and/or a uniform resource locator (URL) associated with a website or a webpage. As another example, the first object may be a presentation object.

The first object may be selected from the first remaining area. For example, the representation of the first object may be “dragged” from the first remaining area and “dropped” to the second-device icon by the first user. Alternatively or additionally, the representation of the first object may be “copied” or “cut” from the first remaining area and then “pasted” to the second-device icon by the first user. As an example, the representation of the first object may be a “dropped” or “pasted” image, copy, or gesture representing the first object.

The method may also include rendering the first object to produce a first presentation object, e.g., generating and/or retrieving the first presentation object according to the first object. For example, the first presentation object may include a portion of a file, a page of document, a presentation slide, an image, a webpage, a table, a picture, a diagram, text, an audio/video piece, and/or at least a portion of a spreadsheet.

The method may also include displaying a first copy of the first presentation object in the second display area in response to the action of receiving the representation of first object and/or the action of rendering the first object.

Similarly, the method may enable other copies of the first presentation object to be displayed in other display areas of other discovered listeners' devices, for example, through the first user's “drag-and-drop” or “copy-and-paste” actions. In one or more embodiments, the method may enable copies of a presentation object to be displayed in the display areas of all devices indicated in the peer window through a single “drag-and-drop” or “copy-and-paste” action performed by the first user that “drops” or “pastes” a representation of an object into the peer window. As can be appreciated, the method may not require the listeners to enter any passcode/key or to perform any log-in actions to have access to the presentation material. Advantageously, substantial convenience for the listeners may be provided.

One or more embodiments of the invention may also enable presentation participants, such as the first user, the second user, and/or one or more other users, to insert copies of one or more other presentation objects into the existing presentation material shown to the users through one or more “drag-and-drop” and/or “copy-and-paste” actions. These other presentation objects may have various file formats that may not need to be in the same file format as the previously-prepared presentation material, which may include the first presentation object. Advantageously, interactions during the presentation may be facilitated, and the effectiveness of the presentation may be substantially enhanced.

One or more embodiments of the invention relate to one or more devices for performing one or more steps in one or more of the above methods.

One or more embodiments of the invention relate to a hub device for facilitating presentation made by at least a first user to a set of users that includes at least a second user. The first user may be a user of a first device; the first device may have or may be associated with a first display area. The second user may be a user of a second device; the second device may have or may be associated with a second display area. For example, each of the devices may represent a computing device, a communication device, a presentation device, and/or an entertainment device, such as a computer, a cellular phone, a projector, and/or a video game console.

The hub device may include a connection mechanism for coupling the first device with a set of devices to provide data connection between the first device and the set of devices, the set of device including at least the second device. For example, the data connection may include one or more wired and/or wireless links for transmitting data. The hub device may also include a storage unit for storing at least a computer-readable program. For example, the computer-readable program may include peer-to-peer software. The hub device may also include a detection mechanism for detecting, among the set of devices, one or more target devices that do not have any copy of the computer-readable program.

The hub device and/or the computer-readable program may generate one or more copies of the computer-readable program based on the number of the target device(s) for the one or more copies of the computer-readable program to be installed in the target device(s). In one or more embodiments, the hub device may proactively push (or transmit) the one or more copies of the computer-readable programs to the target device(s).

A first copy of the computer-readable program may enable the first device to provide a second-device icon in the first display area if the first device has the first copy of the computer-readable program and if the second device has a second copy of the computer-readable program. The second-device icon may be associated with the second device and/or the second user.

The first copy of the computer-readable program may also enable the first device to receive a representation of a first object at the second-device icon. For example, the first object may be an icon that represents or is associated with a digital file. As another example, the first object may be a file directory path, an Internet Protocol (IP) address, and/or a uniform resource locator (URL) associated with a file, a website, and/or a webpage.

The first object may be selected from the first display area. For example, the representation of the first object may be “dragged” from the first remaining area and “dropped” to the second-device icon by the first user. Alternatively or additionally, the representation of the first object may be “copied” or “cut” from the first remaining area and then “pasted” to the second-device icon by the first user. As an example, the representation of the first object may be a “dropped” or “pasted” image, copy, or gesture representing the first object.

The first copy of the computer-readable program may also enable the first device to render the first object to produce a first presentation object. In one or more embodiments, the second copy of the computer-readable program may enable the second device to render a copy of the first object to produce the first presentation object. In one or more embodiments, the hub device may perform the rendering, thereby reducing processing resource requirements on the first device and/or the second device.

The second copy of the computer-readable program may enable the second device to displaying a first copy of the first presentation object in the second display area.

As can be appreciated, the hub device may proactively and effectively provide copies of the computer-readable program to the connected target devices that need the computer-readable program. A presenter (e.g., the first user) of a presentation may not need to wonder which application to install and to use in order to show presentation material; listeners (e.g., the second user) of the presentation may not need to wonder which application to install and to use in order to view the presentation material. Advantageously, substantial convenience may be provided for the participants of the presentation.

Copies of the computer-readable program in the participants' devices may enable the participants (including the first user, the second user, and/or one or more other users) to insert copies of one or more other presentation objects (e.g., of various file formats) into the displayed presentation material through one or more “drag-and-drop” and/or “copy-and-paste” actions. Advantageously, interactions during the presentation may be facilitated, and the effectiveness of the presentation may be substantially improved.

The features and advantages of the present invention may be better understood with reference to the figures and discussions that follow.

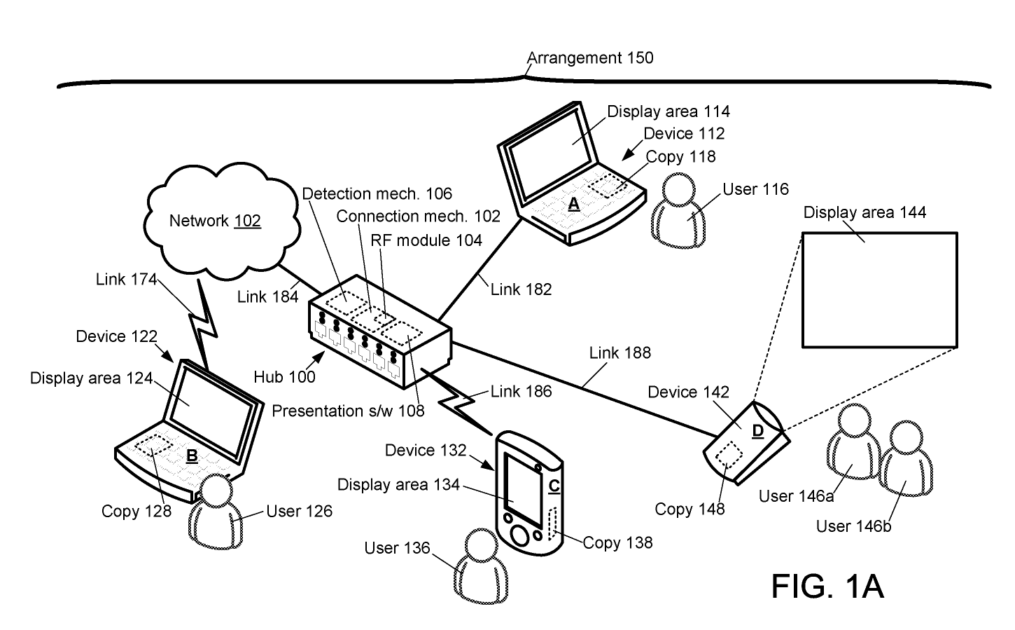

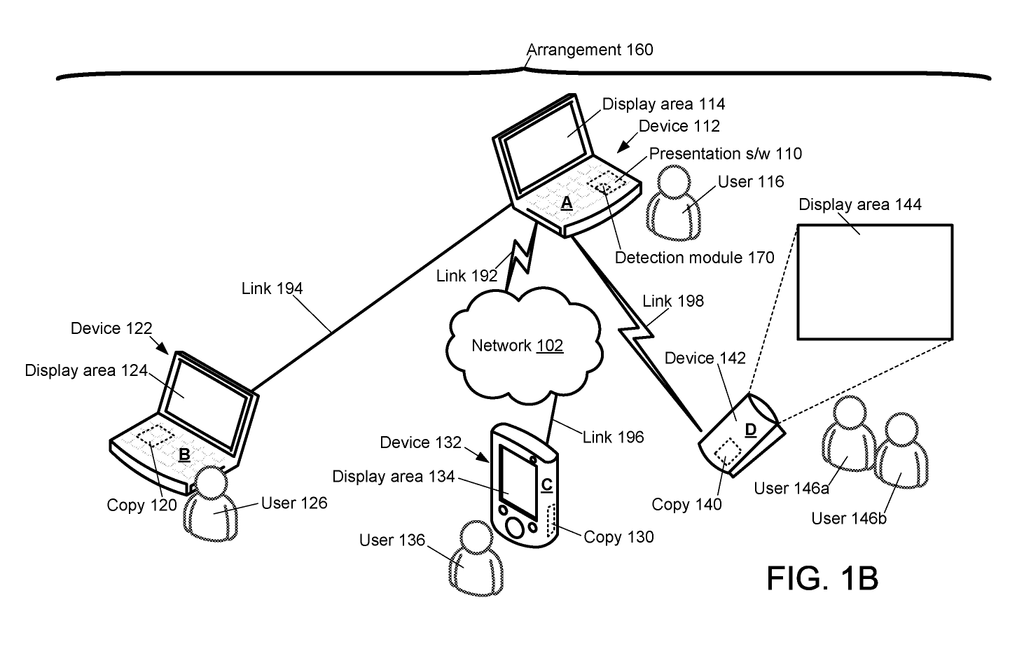

FIG. 1A shows a schematic diagram illustrating an arrangement 150 including a hub device 100 coupled with other devices (such as device 112, device 122, device 132, and device 142) for facilitating presentation in accordance with one or more embodiments of the present invention. For example, each of the devices may represent a computing device, a communication device, a presentation device, and/or entertainment device, such as a computer, a cellular phone, a personal digital assistant, a projector, and/or a video game console.

Each of the devices may be used by one or more users. For example, device 112 (or device A) may be used by a user 116; device 122 (or device B) may be used by a user 126; device 132 (or device C) may be used by a user 136; and device 142 (or device D) may be used by a user 146a, a user 146b, etc. The users may be participants of the presentation.

Each of the devices may have and/or may be associated with at least a display area. A display area may represent all displaying area associated with a device for emitting or reflecting light in various colors simultaneously in different portions of the display area to show images, wherein the images may be generated with use of at least software in the device. For example, a display area may represent the viewable area of a liquid crystal display implemented in or connected to a device. As another example, a display area may represent the projected area produced by an electronic device or by an external projecting device connected thereto.

In the example of FIG. 1A, device 112 may include a display area 114; device 122 may include a display area 124; device 132 may include a display area 114; and device 142 may be associated with a display area 144. Although the display areas are shown as rectangles in the example of FIG. 1A, display areas may have one or more other shapes in one or more embodiments.

Hub device 100 may include a connection mechanism 102, e.g., including a radio frequency module 104, for coupling the devices with one another to provide data connection between the devices. For example, the data connection may include one or more wired and/or wireless data communication links, such as one or more of links 182, 184, 174, 186, and 188 and/or network 102, for transmitting data between devices. Network 102 may represent an ad-hoc network, an intranet, and/or the Internet.

Hub device 100 may also include a storage unit (e.g., a flash memory, a hard disk drive, or an optical disk) for storing at least a computer-readable program for facilitating the presentation; the computer-readable program is illustrated as presentation software 108. In one or more embodiments, the presentation software 108 may include peer-to-peer software for the devices to communicate in a peer-to-peer fashion. Accordingly, arrangement 150 of the invention may not require client-server architecture and may not require Internet connection. Advantageously, potential problems associated with insufficient server processing capacity and/or insufficient network bandwidth may be prevented.

Hub device 100 may also include a detection mechanism 106, which may include one or more hardware components and/or one or more software components, for detecting one or more target devices among the devices that do not have any copy (or any version) of presentation software 108. In one or more embodiments, detection mechanism 106 may be enabled at least partially by presentation software 108. Hub device 100 and/or presentation software 108 may generate/duplicate one or more copies of presentation software 108 based on the number of the target devices, which may need presentation software 108 (and which may be compatible with presentation software 108), such that the one or more copies of presentation software 108 may be installed in the target device(s).

For example, if each of devices 122 and 142 does not have a copy of presentation software 108 installed therein when being connected to hub device 100, and if both devices 112 and 142 already have presentation software 108 before connecting to hub device 100, two copies of presentation software 108 may be generated, one for each of devices 122 and 142. As a result, each of device 112, device 122, device 132, and device 142 may have a copy of presentation software 108, illustrated as copy 118, copy 128, copy 138, and copy 148, respectively, of presentation software 108 installed therein before the presentation is started.

In one or more embodiments, hub device 100 may detect one or more incompatible devices that are connected to hub device 100 but are not suitable for installing presentation software 108. Hub device 100 may not duplicate presentation software 108 for incompatible devices. Hub device may provide a message to the incompatible device, the device identified as the presenter's device, and/or other connected devices for reporting that the incompatible device(s) may not have one or more features provided by presentation software 108. For example, if device 142, e.g., a projector, is not suitable for installing presentation software 108, copy 148 may not exist and may not be generated by hub device 100, and some features of presentation software 108 may not be available to device 142. Nevertheless, device 142 may still be able to receive and show presentation material provided by one or more other devices connected to hub device 100.

In one or more embodiments, hub device 100 may proactively push/transmit generated copies of presentation software 108 to the target devices that need presentation software 108 and that are suitable for executing presentation software 108. Alternatively or additionally, hub device 100 may provide a message to each of the target devices to request downloading a copy of presentation software 108 (wherein the download may be started by a single click on a button by the associated user). Accordingly, the presenter of the presentation, such as user 116 of device 112, may not need to wonder what application to install on device 112 in order to show presentation material; listeners of the presentation, such as the other users, may not need to wonder which application to install on their respective devices in order to view the presentation material. Advantageously, substantial convenience may be provided for the participants of the presentation.

FIG. 1B shows a schematic diagram illustrating an arrangement 160 including connected devices, such as devices 112, 122, 132, and 142 associated with respective display areas and users as discussed in the example of FIG. 1A, for facilitating presentation in accordance with one or more embodiments of the present invention. Arrangement 160 may not need a hub device.

In arrangement 160, device 112 may be preinstalled a copy of a computer-readable program, illustrated as presentation software 110, for facilitating the presentation. Device 112 may be connected to devices 122, 132, and 142 for data communication through one or more wired communication links and/or one or more wireless communication links, such as one or more of links 192, 194, 196, and 198 and/or network 102. Network 102 may represent an ad-hoc network, an intranet, and/or the Internet.

In a manner similar to the software duplicating/generating actions performed by hub device 100 discussed in the example of FIG. 1A, device 112 (e.g., enabled by a detection module 170 of presentation software 110) may detect, among the devices connected to device 112, one or more target devices that do not have any copy (or any version) of presentation software 110. Device 112 and/or presentation software 110 may generate/duplicate one or more copies of presentation software 110 based on the number of the target devices, which may need presentation software 110 (and which may be compatible with presentation software 110), such that the one or more copies of presentation software 110 may be installed in the target device(s). As a result, each of device 122, device 132, and device 142 also may have a copy of presentation software 110, illustrated as copy 120, copy 130, and copy 140, respectively, of presentation software 110 installed therein before the presentation is started.

In one or more embodiments, device 112 may detect one or more incompatible devices that are connected to hub device 100 but are not suitable for installing presentation software 110. Device 112 may duplicate presentation software 110 for an incompatible device. Device 112 may provide a message to the incompatible device, the device identified as the presenter's device (which may be device 112 or another device), and/or other connected devices for reporting that the incompatible device may not have one or more features provided by presentation software 110. For example, if device 142, e.g., a projector, is not suitable for installing presentation software 108, copy 140 may not exist and may not be generated by device 112. Nevertheless, device 142 may still be able to receive and show presentation material provided by one or more other devices connected to device 142 (and equipped with a copy of presentation software 110).

In one or more embodiments, device 112 may proactively push/transmit generated copies of presentation software 110 to the target devices that need presentation software 110 and that are suitable for executing presentation software 110. Alternatively or additionally, device 112 may provide a message to each of the target devices to request downloading a copy of presentation software 110 (wherein the download may be started by a single click on a button by the associated user). Accordingly, the presenter of the presentation, such as user 116 of device 112 or a user of another device, may not need to wonder what application to install and use in order to show presentation material; listeners of the presentation, such as the other users, may not need to wonder which application to install and use in order to view the presentation material. Advantageously, substantial convenience may be provided for the participants of the presentation.

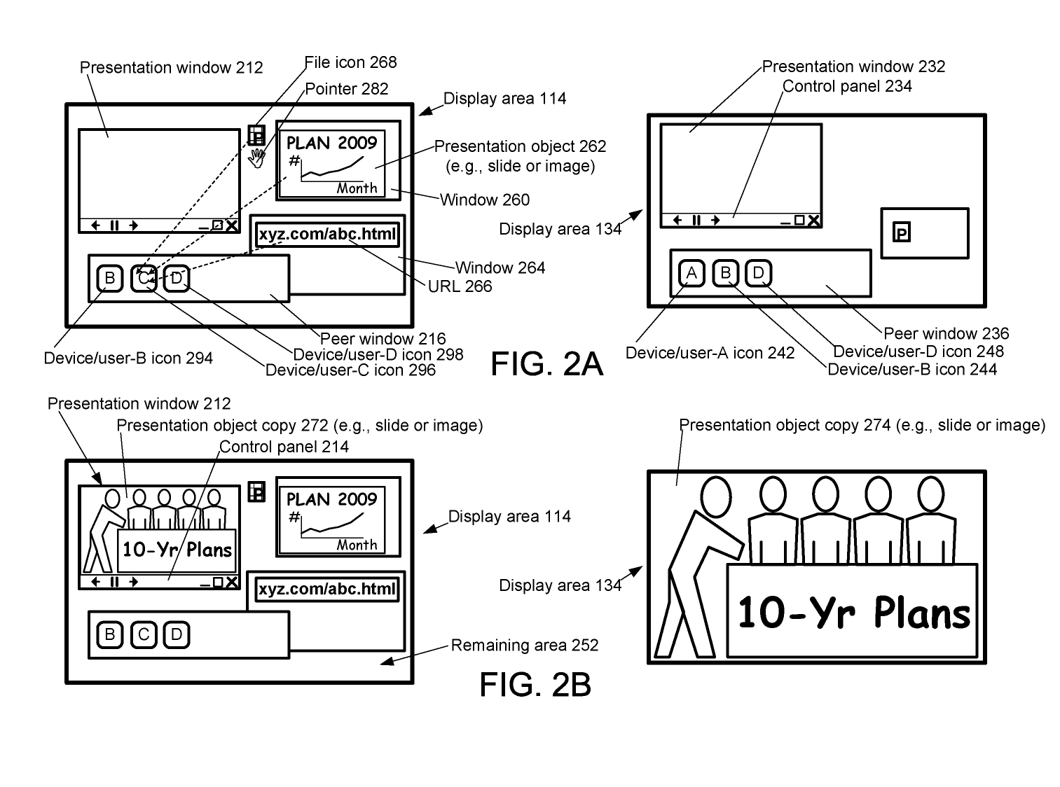

FIG. 2A shows a schematic diagram illustrating one or more steps in a method for facilitating presentation in accordance with one or more embodiments of the present invention. The method may be discussed with reference to arrangement 150 illustrated in the example of FIG. 1A and/or arrangement 160 illustrated in the example of FIG. 1B. For facilitating discussion, as an example, user 116 using device 112 may be assumed to be the primary presenter in this presentation, though one or more of other users also may be a primary presenter in the presentation.

In the method, hub device 100 and/or device 112 may detect one or more devices that are connected to the first device. For example, the detected devices may be directly or indirectly connected to the first device through one or more of a wired connection, a wireless connection, an ad-hoc network, an intranet, and the Internet.

Hub device 100 and/or device 112 may discover, for example, device 122 (or device B), device 132 (or device C), and device 142 (or device D), which are connected to device 112. In response to the discovery, enabled by the presentation software installed on device 112 (e.g., copy 118 of presentation software 108 or presentation software 110), device 112 may provide a device/user-B icon 294, a device/user-C icon 296, and a device/user-D icon 298 in display area 114 of device 112.

In one or more embodiments, device/user-B icon 294, device/user-C icon 296, and device/user-D icon 298 may be provided in a peer window 216 in display area 114. Peer window 216 may show all the devices that are connected to device 112 and that are discovered by device 112 and/or hub device 100.

Hub device 100 and/or device 112 may associate each device/user icon with a discovered device and/or an appropriate user. For example, device/user C icon 296 may be associated with device 132 and/or user 136 (illustrated in the example of FIG. 1A or 1B). Each device/user icon may show a symbol, a number, and/or text that may represent the associated device and/or the associated user for, for example, identification purposes. According to the identification provided by each device/user icon, user 116 may determine whether to provide presentation material to the associated device (and/or the associated user). Advantageously, at least some security and/or confidentiality problems may be prevented.

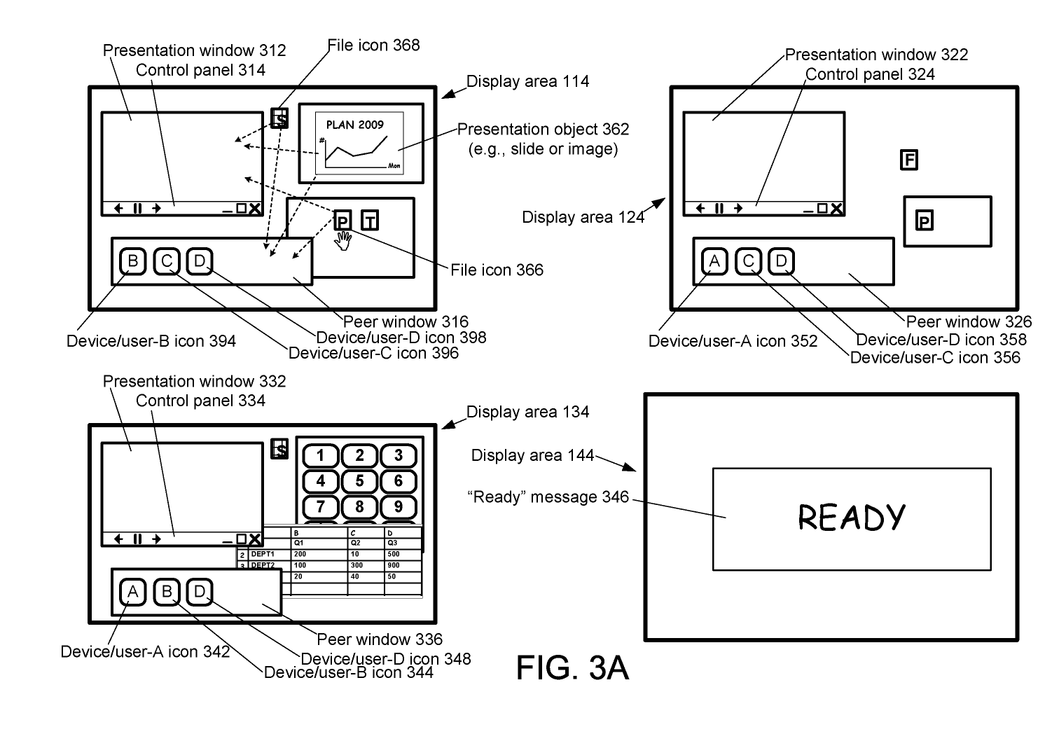

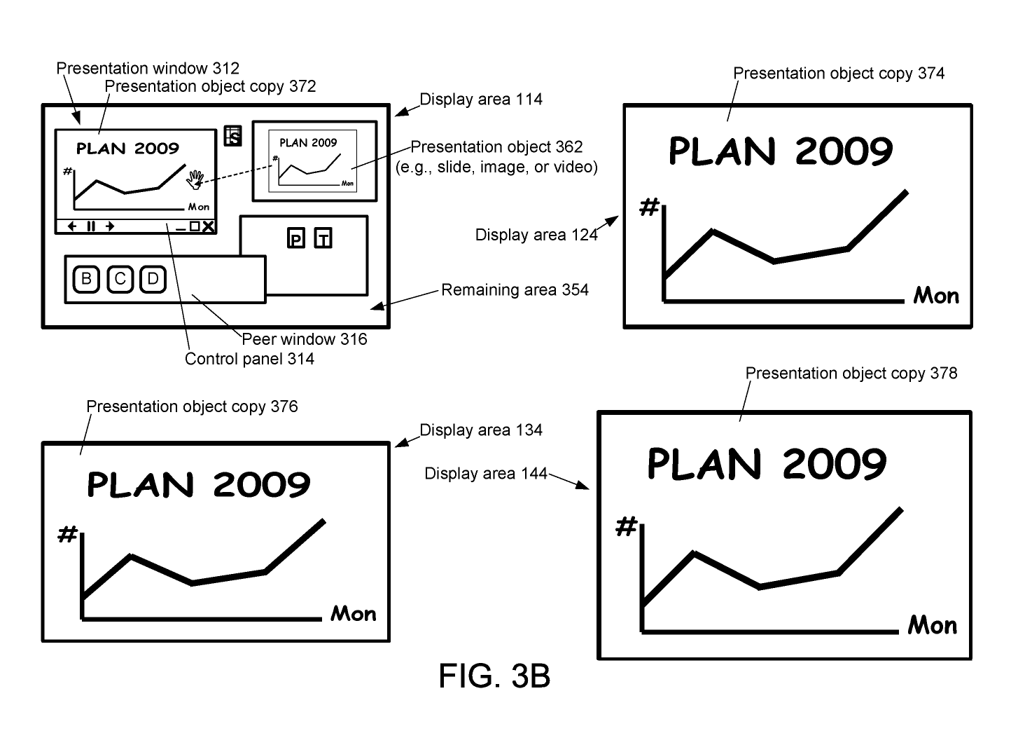

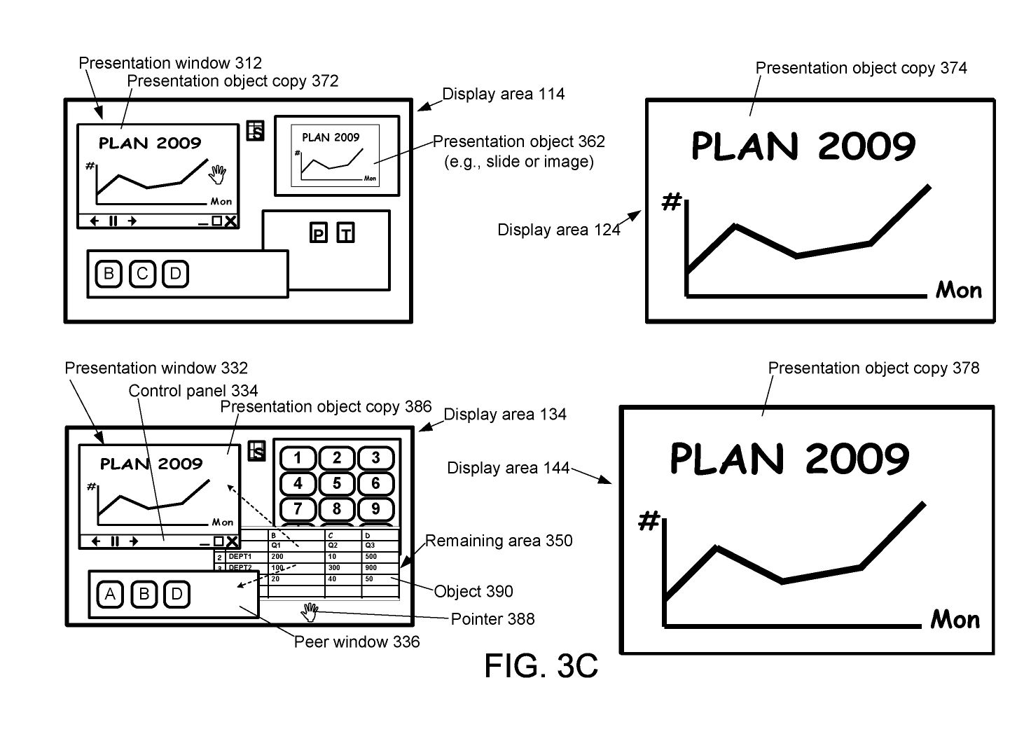

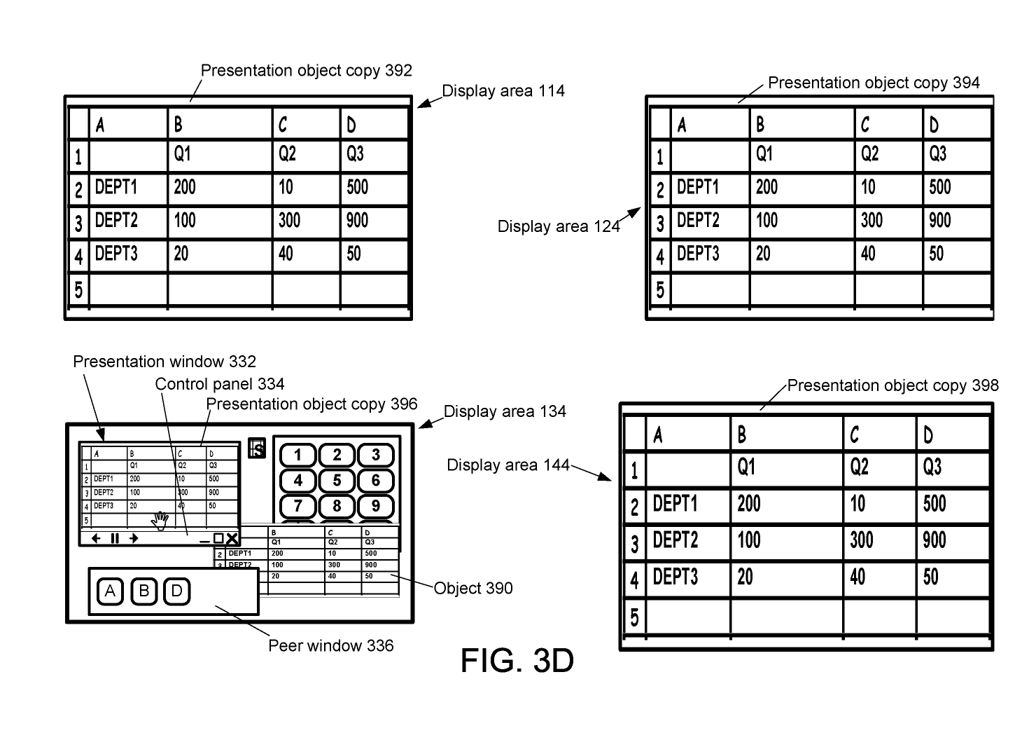

Similarly, enabled by a copy of the presentation software, each of the other connected user devices (i.e., listener devices) may provide peer device/user icons in the respective associated display area. The peer device/user icons may be associated with appropriate peer devices and/or peer users. For example, as also illustrated in the example of FIG. 2A, device 132 may provide a device/user-A icon 242, a device/user-B icon 244, and a device/user-D icon 248 in a peer window 236 in display area 134 of device 132. The peer device/user icons may enable the listeners to insert presentation material/objects into the presentation through “drag and drop” and/or “copy and paste” actions, as will be discussed below with reference to the examples of FIGS. 3A-3D.

Once user 116 has determined which user(s) and/or which device(s) the presentation material should be shown to (based on identification provided by peer device/user icons), user 116 may use a pointing device (represented by a pointer 282) to “drag-and-drop” or “copy-and-paste” a representation of an object to the selected device/user icon(s) to provide the presentation material, thereby starting the presentation.

For example, the object may be an icon, such as file icon 268 that represents or is associated with a digital file, such as a presentation file, a word editor file, a spreadsheet file, an image file, a drawings file, an audio/video file. As another example, the object may be a file directory path, an Internet Protocol (IP) address, and/or a uniform resource locator (URL), such as URL 266 located in a window 264 in display area 114, associated with a file, a website, and/or a webpage. As another example, the object may be a presentation object 262, such as a presentation slide, an image, or a video clip, shown in window 260 in display area 114. The representation of the object may be a “dropped” or “pasted” image, copy, or gesture representing the object.

User 116 may directly “drag-and-drop” or “copy-and-paste” the representation of the object to one device/user icon at a time. User 116 may also “drag-and-drop” or “copy-and-paste” the representation of the object to multiple selected/highlighted device/user icons for simultaneously showing the presentation material on multiple devices. User 116 may also “drag-and-drop” or “copy-and-paste” the representation of the object to a portion of peer window 216 that is outside the device/user icons for simultaneously showing the presentation material on all the discovered peer devices. Device 112 may receive the representation of the object at the one or more selected device/user icons and/or peer window 216.

In response to the “drag-and-drop” or “copy-and-paste” action, device 112 and/or hub device 100 may render the object to produce a presentation object. For example, the presentation object may include a presentation slide, an image, a webpage, a table, a picture, a diagram, text, an audio/video piece, and/or a portion of a spreadsheet. In one or more embodiments, rendering (e.g., generating and/or retrieving) presentation objects may be performed at least in part at peer devices, such as device 132.

In response to the “drag-and-drop” or “copy-and-paste” action, the action of receiving the representation of the object, and/or the action of rendering the presentation object, the one or more selected peer devices may display a copy of the presentation object in respective associated display areas, as illustrated in the example of FIG. 2B.

FIG. 2B shows a schematic diagram illustrating one or more steps in a method for facilitating presentation in accordance with one or more embodiments of the present invention.

As discussed in the example for FIG. 2A, in response to the “drag-and-drop” or “copy-and-paste” action, the action of receiving the representation of the object, and/or the action of rendering the presentation object, the one or more selected peer devices (i.e., listener devices) may display a copy of the presentation object in respective associated display areas. For example, after a representation of an object is “dragged and dropped” (or “copied and pasted”) to device/user-C icon 296, as illustrated in the example of FIG. 2B, display area 134 of device 132 may automatically display a copy of the presentation object rendered by, for example, device 132 and/or device 112, as illustrated by presentation object copy 274. The listeners of the presentation, such as user 136, may not need to enter any passcode/key or to perform any log-in actions to have access to the presentation material. Advantageously, substantial convenience for the listeners may be provided.

In response to the “drag-and-drop” or “copy-and-paste” action, the action of receiving the representation of the object, and/or the action of rendering the presentation object, device 112 may provide a presentation window 212 in display area 114. Device 112 may show a copy of the presentation object, as illustrated by presentation object copy 272. Device 112 may also provide a control panel 214 for enabling user 116 to control the flow/navigation of the presentation material. Presentation object copy 272 may be scaled to fit in presentation window 212. Other control features, such as zooming, panning, navigation features, may be provided at presentation window 212 for user 116 to manipulate the way the presentation object is presented by manipulating presentation object copy 272. The changes made to presentation object copy 272 may be reflected on other presentation object copies shown on other peer devices, such as presentation object copy 274.

Presentation window 212 may be smaller than display area 114 with a remaining area 252 existing outside presentation window 212 and inside display area. Remaining area 252 may enable user 116 to “drag” and/or “copy” objects from remaining area 252 for performing further “drag and drop” and/or “copy and paste” actions in conducting the presentation. User 116 may “drag” and/or “copy” objects from remaining area 252 and “drop” and/or “paste” representations of the objects to presentation window 212, one or more device/user icons, and/or peer window 216 to insert presentation material.

Remaining area 252 may also enable user 116 to view other objects, such as reference material for enriching the presentation, jokes for waking up the listeners, pop-up messages, or incoming messages, besides presentation object copy 272. Advantageously, substantial convenience and/or privacy may be provided for user 116.

In one or more embodiments, the presentation object copies shown on other peer devices (i.e., the listener devices) may fill the display areas associated with respective listener devices. For example, presentation object copy 274 may fill display area 134 with no remaining area of display 134. With each of the listener's display area being filled with a copy of the presentation object, the listeners may not be able to see what is shown in remaining area 252. Advantageously, potential privacy and/or confidentiality problems for user 116 and potential distraction problems for the listeners during the presentation may be avoided.

Referring back to FIG. 2A, in one or more embodiments, device 112 may provide presentation window 212 in display area 114 in response to the previously-discussed device discovery action, before a representation of an object is “dragged and dropped” or “copied and pasted” to a device/user icon or peer window 216. Presentation window 212 may enable user 116 to “drag and drop” or “copy and paste” a representation of an object to presentation window 212 to show copies of the associated presentation object on all discovered peer devices (i.e., listener devices), thereby starting the presentation.

In one or more embodiments, device 132 may provide a presentation window 232 in display area 134 in response to the previously-discussed device discovery action. In one or more embodiments, device 132 may provide presentation window 232 in display area 134 in response to a “drag and drop” or “copy and paste” action performed to peer window 236 or one or more device/user icons on device 132. Presentation window 232 may enable user 136 to “drag and drop” or “copy and paste” a representation of an object to presentation window 232 to show copies of the associated presentation object on all discovered peer devices (i.e., listener devices), thereby inserting presentation material to the presentation. Advantageously, interactions during the presentation may be facilitated, and the effectiveness of the presentation may be substantially improved. Interactions in the presentation through “drag and drop” and/or “copy and paste” actions are further discussed with references to the examples of FIGS. 3A-3D.

In one or more embodiments, if user 116 “drags and drops” a representation of a first object to device/user-B icon 294 and “drags and drops” a representation of a second object to device/user-C icon 296, then device 112 may generate two presentation windows, one for each of the first object and the second object. In response, device 122 may show a presentation object copy associated with the first object, and device 132 may show a presentation object copy associated with the second object; user 126 and user 136 may see presentation object copies of different presentation objects.

FIG. 3A shows a schematic diagram illustrating one or more steps in a method for facilitating presentation in accordance with one or more embodiments of the present invention. The method may be discussed with reference to arrangement 150 illustrated in the example of FIG. 1A and/or arrangement 160 illustrated in the example of FIG. 1B. For facilitating discussion, as an example, user 116 using device 112 may be assumed to be the primary presenter in this presentation, though one or more of other users also may be a primary presenter in the presentation.

In the method, hub device 100 and/or device 112 may detect one or more discovered devices that are connected to the first device. Hub device 100 and/or device 112 may provide copies of presentation software (e.g., presentation software 108 or presentation software 110) to appropriate discovered devices.

Each of the devices equipped with a copy of the presentation software may provide device/user icons associated with other connected devices (or peer devices) in its respective associated display area. For example, device 112 may provide a device/user-B icon 394 (associated with device 122 and/or user 126), a device/user-C icon 396 (associated with device 132 and/or user 136), and a device/user-D icon 398 (associated with device 142 and/or user 146) in a peer window 316 in display area 114 of device 112. As another example, device 122 may provide a device/user-A icon 352 (associated with device 112 and/or user 116), a device/user-C icon 356 (associated with device 132 and/or user 136), and a device/user-D icon 358 (associated with device 142 and/or user 146) in a peer window 326 in display area 124 of device 122. As another example, device 132 may provide a device/user-A icon 342 (associated with device 112 and/or user 116), a device/user-B icon 344 (associated with device 122 and/or user 126), and a device/user-D icon 348 (associated with device 142 and/or user 146) in a peer window 336 in display area 134 of device 132. Device 142, which may not be able to have a copy of the presentation software installed thereon, may provide a message 346 in display area 144 for informing users 146a and 146b that the presentation is about to start.

Device 112 may also provide a presentation window 312 and/or a control panel 314 in display area 114. In one or more embodiments, presentation window 312 and/or control panel 314 may not be provided until at least a representation of an object, such as a representation of file icon 368, file icon 366, presentation object 362, or a URL, is “dragged and dropped” or “copied and pasted” to peer window 316 or one or more device/user icons therein. Presentation window 312 and/or control panel 314 may be provided in response to the “drag and drop” or “copy and paste” action. Presentation window 312 may show a copy of a presentation object. Control panel may facilitate control of the flow/navigation of the presentation material and/or the manipulation of the presentation object.

In one or more embodiments, presentation window 312 and/or control panel 314 may be provided before the “drag and drop” or “copy and paste” action. For example, presentation window 312 and/or control panel 314 may be provided in response to the device discovery. When, whether, and how presentation window 312 and/or control panel 314 may be provided may be configured by user 116 using a user interface provided by the presentation software.

Similarly, device 132 may provide a presentation window 332 and/or a control panel 334 in display area 134 in response to a “drag and drop” or “copy and paste” to peer window 336 or one or more device/user icons therein; or device 132 may provide presentation window 332 and/or control panel 334 in display area 134 before the “drag and drop” or “copy and paste” action; or device 132 may provide presentation window 332 and/or control panel 334 in display area 134 in response to an command provided by user 136 for escaping from the full-area display mode of device 132, as discussed with reference to the example of FIG. 3C. Device 122 may provide a presentation window 322 and/or a control panel 324 in display area 124 in response to a “drag and drop” or “copy and paste” to peer window 326 or one or more device/user icons therein; or device 122 may provide presentation window 322 and/or control panel 324 in display area 124 before the “drag and drop” or “copy and paste” action; or device 122 may provide presentation window 322 and/or control panel 324 in display area 124 in response to an command provided by user 126 for escaping from the full-area display mode of device 122.

User 116 may “drag and drop” a representation of an object, such as a representation of presentation object 362, to peer window 316 or presentation window 312 to show copies of a presentation object (e.g., presentation object 362) in display areas, e.g., display areas 124, 134, and 144, associated with all connected peer devices, e.g., devices 122, 132, and 142, respectively. The copies of the presentation object are illustrated in the example of FIG. 3B.

FIG. 3B shows a schematic diagram illustrating one or more steps in a method for facilitating presentation in accordance with one or more embodiments of the present invention. After receiving the representation of presentation object 362 at presentation window 312 or peer window 316, as illustrated in the example of FIG. 3B, device 112 may show a copy of presentation object 362, illustrated by presentation object copy 372, in presentation window 312.

In one or more embodiments, device 112 may show presentation object copy 372 in a supplementary window (not shown) in a remaining area 354 outside presentation window 312, without showing presentation object copy 372 in presentation window 312. Presentation window 312 (which may be configured with a smaller size) may be dedicated for receiving representations of objects, the supplementary window, in cooperation with control panel 314, may be used for navigating and manipulating the presentation material.

In one or more embodiments, presentation object copy 372 may be linked to a copy of a file that contains presentation object 362, and control panel 314 may enable user 116 to navigate the copy of the file to show various portions (e.g., other slides, images, and/or videos) of the file in presentation window 312 as well as in display areas associated with peer devices (or listener devices), e.g., devices 122, 132, and 142.

In response to the “drag and drop” or “copy and paste” action that “drops” or “pastes” the representation of presentation object 362 to presentation window 312 or peer window 316, the listener devices may show copies of presentation object 362 in respective associated display area, as illustrated by presentation object copy 374, presentation object copy 376, and presentation object copy 378 shown in display area 124, display area 134, and display area 144, respectively. One or more of the copies of presentation object 362 may be scaled to fit the dimensions of one or more of the display areas. In one or more embodiments, each of the display areas is filled by a copy of presentation object 362.

User 116 may “drag and drop” or “copy and paste” a representation of another object to presentation window 312 or peer window 316 from a remaining area 354 outside presentation window 312. Accordingly, a (rendered) copy of a new presentation object may replace presentation object copy 372 in presentation window 312, and (rendered) copies of the new presentation object may replace copies of presentation object 362 in the display areas associated with the peer devices (or listener devices). The new presentation object is inserted into the previous presentation material to form a new set of presentation material and may also be navigated and/or manipulated as part of the new set of presentation material with use of control panel 376. The inserted new presentation object may have a file/data format that is different from or the same us the file/data format(s) of the previous presentation material. In one or more embodiments, files/data of different formats may be converted into a unified format for the integrated presentation material. Advantageously, substantial flexibility may be provided in modifying the presentation material during the presentation. Changes in presentation window 312 may be reflected on the display areas associated with the peer devices.

FIG. 3C shows a schematic diagram illustrating one or more steps in a method for facilitating presentation in accordance with one or more embodiments of the present invention. In the example of FIG. 3C, device 132 may receive an interruption command from user 136 to turn off the full-screen/full-area display mode of device 132. For example, user 136 may press an “ESC” button, a “clear” button, or a “hang-up” button on device 132 to provide the interruption command.

In response to the interruption command, device 132 may generate and/or reveal presentation window 332 and/or control panel 334, as well as a remaining area 350 outside presentation window 332 and inside display area 134. Device 132 may also show a presentation object copy 386 of presentation object 362 in presentation window 332, wherein presentation object copy 386 may be smaller than presentation object copy 376 shown in the full-screen mode of device 132 (as illustrated in the example of FIG. 3B). Device 132 may also show peer window 336 in display area 134.

User 136 may “drag and drop” or “copy and paste” a representation of an object, such as presentation object 390, from remaining area 350 to presentation window 332 or peer window 336 using a pointing device, e.g., represented by pointer 388, for showing a presentation object rendered from (or generated based on) the object. The object may have a file/data format that is different from or the same as the file/data format of presentation object 362. As an example, presentation object 362 may have an image format, while presentation object 390 may have a spreadsheet format. In one or more embodiments, files/data of different formats may be converted into a unified format for the integrated presentation material. Advantageously, additional presentation material may be effectively and efficiently added and integrated into the presentation with minimized interruption of the presentation.

In response to the “drag and drop” or “copy and paste” action performed by user 136 and/or in response to the action of rendering the object, copies of presentation object 362 may be replaced by copies of presentation object 390, as illustrated in the example of FIG. 3D.

FIG. 3D shows a schematic diagram illustrating one or more steps in a method for facilitating presentation in accordance with one or more embodiments of the present invention. In response to the “drag and drop” or “copy and paste” action performed by user 136 and/or in response to action of rendering the object of which a presentation is “dropped” or “pasted” to presentation window 332 or peer window 336, presentation object copy 386 may be replaced by presentation object copy 396 of presentation object 390, presentation object copy 374 may be replaced by presentation object copy 394 of presentation object 390, presentation object copy 378 may be replaced by presentation object copy 398 of presentation object 390. In addition, device 112 may show presentation object copy 392 of presentation object 390 in display area 114. Presentation object copy 392 may fill display area 114 in one or more embodiments. Accordingly, user 136 may provide comments with reference to presentation object 390 and may refer to presentation object 390 in discussing with user 116 (the primary speaker) as well as other participants of the presentation. User 136 may also use control panel 334 to navigate (and manipulate) the integrated presentation material, which includes the previously-existing presentation material and presentation object 390, with the navigation and changes of the integrated presentation material being shown in presentation window 332 as well as display areas 113, 124, and 144. In one more embodiments, device 112 also may show a control panel to enable user 116 to have control of the presentation material when copies of presentation object 390 from user 136 are being presented.

User 116 may provide an interruption command to turn off the full-screen display mode and generate and/or reveal presentation window 312 and peer window 316 for continuing the presentation. The process may be similar to the process for user 136 and device 132 discussed with reference to the example of 3C. A copy of presentation object 390 may have become part of the integrated presentation material when user 116 continues the presentation, and user 116 may use control panel 314 to navigate back to the copy of presentation object 390 when appropriate.

In a manner similar to the process discussed with reference to the examples for FIGS. 3A-3D, the participants of the presentation, e.g., users 116, 126, and 136 may insert a copy of one or more other presentation objects into the displayed presentation material through one or more “drag-and-drop” and/or “copy-and-paste” actions. These other presentation objects may be in various file formats that may not need to be in the same file format as the existing presentation object/material. Advantageously, interactions during the presentation may be facilitated, and the effectiveness of the presentation may be substantially improved.

As can be appreciated from the foregoing, embodiments of the invention may proactively and effectively provide copies of a suitable software application to devices used by participants of a presentation. The presenter of a presentation may not need to wonder what application to install in order to show presentation material; the listeners of the presentation may not need to wonder what application to install in order to view the presentation material. Advantageously, substantial convenience may be provided for the participants of the presentation.

Embodiments of the invention may provide a presenter of a presentation with a view that is different from the view available to the listeners of the presentation. In particular, a remaining area outside a presentation window that shows the presentation material may be viewable only to the first user when each display area of the listeners' devices is filled with a copy of the presentation material, such that the listeners may not be able to see what is shown in the remaining area. Advantageously, potential privacy and/or confidentiality problems for the presenter and potential distraction problems for the listeners during the presentation may be avoided.

Embodiments of the invention may enable the display of presentation material to be started on listeners' devices through the presenter one or more “drag-and-drop” or “copy-and-paste” actions. The listeners may not need to enter any passcode/key or to perform any log-in actions in order to view the presentation material. Advantageously, substantial convenience for the listeners may be provided.

Embodiments of the invention may enable participants of a presentation to insert (copies of) presentation objects into the displayed presentation material through simple “drag-and-drop” and/or “copy-and-paste” actions. Advantageously, interactions during the presentation may be facilitated, and the effectiveness of the presentation may be substantially improved.

Embodiments of the invention may not require client-server architecture and may not require Internet connection. Advantageously, potential problems associated with insufficient server processing capacity and/or insufficient network bandwidth may be prevented.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for facilitating presentation made by at least a first user to a set of users, the set of users including at least a second user, the first user being a user of a first device, the first device having or being associated with a first display area, the second user being a user of a second device, the second device having or being associated with a second display area, the method comprising:
generating a first presentation window within the first display area, the first presentation window being smaller than the first display area, a first remaining area being formed in the first display area and outside the first presentation window, the first display area representing all displaying area associated with the first device for emitting or reflecting light in various colors simultaneously in different portions of the first display area to show one or more images, the one or more images being generated with use of at least software in the first device;
receiving at the first presentation window a representation of a first object, the first object being selected from the first remaining area;
generating a first presentation object according to the first object; and
filling the second display area with a first copy of the first presentation object, the second display area representing all displaying area associated with the second device for simultaneously emitting or reflecting light of different wavelengths in different portions of the second display area to show at least one image, the at least one image being generated with use of at least software in the second device, the first presentation window and the first remaining area being present in the first display area when the second display area is filled with the first copy of the first presentation object.

2. The method of claim 1 further comprising displaying a second copy of the first presentation object in the first presentation window.

3. The method of claim 1 further comprising displaying a second copy of the first presentation object in a supplementary window, the supplementary window being positioned in the first remaining area.

4. The method of claim 1 further comprising:
detecting one or more devices that are connected to the first device;
discovering the second device;
providing a second-device icon in the first display area;
associating the second-device icon with at least one of the second device and the second user;
receiving a representation of a second object at the second-device icon, the second object being selected from the first display area;
generating a second presentation object according to the second object; and
displaying a first copy of the second presentation object in the second display area in response to at least one of the receiving the presentation of the second object and the generating the second presentation object.

5. The method of claim 4 wherein the displaying the first copy of the second presentation object including at least filling the second display area with the first copy of the second presentation object.

6. The method of claim 4 further comprising:
generating the first presentation window in response to one or more of the receiving the presentation of the second object and the generating the second presentation object; and
displaying a second copy of the second presentation object in the first presentation window.

7. The method of claim 4 wherein the representation of the second object is dragged to the second-device icon from the first display area.

8. The method of claim 1 further comprising:
generating a second presentation window within the second display area, the second presentation window being smaller than the second display area, a second remaining area being formed in the second display area and outside the second presentation window;
receiving a representation of a second object at the second presentation window, the second object being selected from the second remaining area;
generating a second presentation object according to the second object; and
replacing the first copy of the first presentation object with a first copy of the second presentation object in the second presentation window.

9. The method of claim 8 further comprising displaying a second copy of the second presentation object in the first presentation window.

10. The method of claim 8 further comprising replacing a second copy of the first presentation object with a second copy of the second presentation object in the first presentation window.

11. The method of claim 8 further comprising:
receiving an interruption command from the second user through the second device; and
performing the generating the second presentation window in response to the interruption command.

12. The method of claim 8 wherein the set of users further including at least a third user, the third user being a user of a third device, the third device having or being associated with a third display area, the method further comprising replacing a third copy of the first presentation object with a third copy of the second presentation object in the third display area, the third copy of the first presentation object being previously displayed in the third display area.

13. The method of claim 1 further comprising:
receiving a representation of a second object at the first presentation window, the second object being selected from the first remaining area, the first object being associated with a first file format, the second object being associated with a second file format, the second file format being different from the first file format;
generating a second presentation object according to the second object; and
replacing the first copy of the first presentation object with a first copy of the second presentation object in the second display area, the first copy of the second presentation object filling the second display area when the first presentation window and the first remaining area are present in the first display area.

14. The method of claim 13 further comprising replacing a second copy of the first presentation object with a second copy of the second presentation object in the first presentation window.

15. The method of claim 1 wherein the second device represents a digital picture frame.

16. A method for facilitating presentation made by at least a first user to a set of users, the set of users including at least a second user, the first user being a user of a first device, the first device having or being associated with a first display area, the second user being a user of a second device, the second device having or being associated with a second display area, the method comprising:
detecting one or more devices that are connected to the first device;
discovering the second device;
providing a second-device icon in the first display area;
associating the second-device icon with at least one of the second device and the second user;
receiving at the second-device icon a representation of a first object, the first object being selected from the first display area, the first display area representing all displaying area associated with the first device for simultaneously emitting or reflecting light in various colors to show one or more images generated using at least software in the first device;
generating a first presentation object according to the first object; and
displaying a first copy of the first presentation object in the second display area in response to at least one of the receiving the representation of first object and generating the first presentation object.

17. The method of claims 16 wherein the displaying the first copy of the first presentation object including at least filling the second display area with the first copy of the first presentation object, the second display area representing all displaying area associated with the second device for simultaneously emitting or reflecting light of different wavelengths to show at least an image generated using at least software in the second device.

18. The method of claim 16 further comprising:
generating a first presentation window within the first display area in response to one or more of the receiving representation of the first object and the generating the first presentation object, the first presentation window being smaller than the first display area, a first remaining area being formed in the first display area and outside the first presentation window; and
displaying a second copy of the first presentation object in the first presentation window.

19. The method of claim 18 further comprising:
receiving a representation of a second object at the first presentation window, the second object being selected from the first remaining area;
generating a second presentation object according to the first object;
replacing the first copy of the first presentation object with a first copy of the second presentation object in the second display area; and
replacing the second copy of the first presentation object with a second copy of the second presentation object in the first presentation window.

20. The method of claim 19 wherein the first object is associated with a first file format, the second object is associated with a second file format, and the second file format is different from the first file format.

21. A hub device for facilitating presentation made by at least a first user to a set of users, the set of users including at least a second user, the first user being a user of a first device, the first device having or being associated with a first display area, the second user being a user of a second device, the second device having or being associated with a second display area, the hub device comprising:
a connection mechanism for coupling the first device with a set of devices to provide data connection between the first device and the set of devices, the set of device including at least the second device;
a storage unit for storing at least a computer-readable program; and
a detection mechanism for detecting, among the set of devices, one or more target that do not have any copy of the computer-readable program,
wherein at least one of the hub device and the computer-readable program is configured to generate a number of one or more copies of the computer-readable program based on a number of the one or more target devices for the one or more copies of the computer-readable program to be installed in the one or more target devices,
a first copy of the computer-readable program is configured to enable the first device to provide a second-device icon in the first display area if the first device has the first copy of the computer-readable program and if the second device has a second copy of the computer-readable program, the second-device icon being associated with at least one of the second device and the second user,
the first copy of the computer-readable program is further configured to enable the first device to receive a representation of a first object at the second-device icon, the first object being selected from the first display area,
the first copy of the computer-readable program is further configured to enable the first device to render the first object to produce a first presentation object, and
the second copy of the computer-readable program is configured to enable the second device to displaying a first copy of a first presentation object in the second display area.

22. The hub device of claim 21 further comprising a radio frequency module for coupling the hub device with one or more of the set of devices.

23. The hub device of claims 21 wherein the second copy of the computer-readable program is configured to enable the second device to fill the second display area with the first copy of the first presentation object when the first copy of the computer-readable program drives the first device to show a second copy of the first presentation object in a presentation window, the presentation window being in the first display area and being smaller than the first display area.
